(19) United States
(12) Patent Application Publication
(10) Pub. No.: US 2006/0172754 A1
(43) Pub. Date: Aug. 3, 2006

(54) Method and system for servicing full duplex call in push-to-talk over cellular

(75) Inventors: Dong-Cheol Shin, Suwon-si (KR); Young-Ki Jeon, Hwaseong-si (KR); Ju-Young Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/340,585

(22) Filed: Jan. 27, 2006

(30) Foreign Application Priority Data
Feb. 1, 2005 (KR) 2005-9306

(51) Int. Cl. H04B 7/00; H04Q 7/20

(52) U.S. Cl. 455/518

(57) ABSTRACT

A method and system are provided for servicing a full duplex call in Push-To-Talk over cellular (PoC) in a communication system including at least two or more calling/called terminals for receiving a Push-To-Talk (PTT) service and a mobile network for providing the PTT service to the calling/called terminals. The calling terminal generates a full-duplex mode request message and transmits the full-duplex mode request message to the mobile network. The mobile network transmits the full-duplex mode request message to a PoC server that provides a PoC service to the calling terminal. Upon receiving the full-duplex mode request message, a PoC server of the calling terminal sets the calling terminal to a full duplex mode, and transmits the full-duplex mode request message to a PoC server of the called terminal. The PoC server of the called terminal transmits the full-duplex mode request message to the called terminal, and performs a call between the calling terminal and the called terminal in the full duplex mode if the called terminal responds to the full-duplex mode request message.

### CROSS-REFERENCE TO RELATED APPLICATIONS

This application claims the benefit under 35 U.S.C. § 119(a) of a Korean Patent Application Serial No. 2005-9306 filed in the Korean Intellectual Property Office on Feb. 1, 2005, the entire contents of which are hereby incorporated by reference.

### BACKGROUND OF THE INVENTION

1. Field of the Invention

The present invention relates generally to a method and system for servicing a voice call in a mobile communication system. In particular, the present invention relates to a method and system for servicing a voice call with a packet data service.

2. Description of the Related Art

A mobile communication system was developed to mainly provide a voice service to users. With the development of communication technologies, a mobile communication system can now transmit E-mail or moving image data as well as voice data, to the users. To transmit the high-speed data, current mobile communication system provides a packet data service to the users. In addition, current mobile communication system provides voice service based on the packet data service, like Voice over Internet Protocol (VoIP) and Push-To-Talk (PTT). PTT service is a typical voice service based on packet data service.

Generally, a PTT service refers to a service for allowing users to make conversation on a point-to-point (1:1) or point-to-multipoint (1:N) basis with a switch being pushed, like the conventional Trunked Radio System (TRS) or Walkie-Talkie service.

Compared with a general cellular phone having a long waiting time, the PTT service provides a fast communication service and a low-service charge system because the users can immediately make simple conversation by talking with a switch being pushed, without the unnecessary process of performing a dialing operation and exchanging ring tones between users.

Push-To-Talk over Cellular (PoC) is accomplished by implementing the PTT service in mobile communication networks such as CDMA/WCDMA-based cellular system, IEEE 802.11x-based wireless LAN, IEEE 802.16/20 and High-speed Portable Internet (HPi). Presently, American CDMA PTT service providers have organized an Open Mobile Alliance (OMA) forum, centering on Motorola, Simense and Ericson, to solve expected problems through a discussion on the ongoing CDMA PTT service standardization.

A conventional PTT service network can use a Session Initiation Protocol (SIP) as a protocol for PTT service, for signaling transmission, and use a Real Time Control Protocol (RTCP) for real-time voice packet transmission. The SIP, a point-to-point and server-client signaling protocol, serves to allow terminals to exchange necessary session information with each other before initiating a call and delete the session information after the call ends.

The current PTT service is classified into a general PoC standard and an IP Multimedia System (IMS)-based PoC standard.

However, in both schemes described above, when performing point-to-multipoint group communication using PTT, only the single sender that acquired a floor through floor control using half duplex can send a signal and the other users should only receive signals until the sender drops the floor. Such a call method can be efficient when many group members are participating in the call. However, when performing a point-to-point direct call using a half duplex scheme rather than a full duplex scheme, the call method has a low response speed and a long call waiting time, compared with the general voice call.

### SUMMARY OF THE INVENTION

It is, therefore, an object of the present invention to provide a method and system for servicing a point-to-point direct call between users in PoC service.

It is another object of the present invention to provide a method and system for servicing a point-to-point direct call between users without performing floor control in PoC service.

According to one aspect of the present invention, there is provided a method for servicing a full duplex call in Push-To-Talk over cellular (PoC) in a communication system including at least two or more calling/called terminals for receiving a Push-To-Talk (PTT) service and a mobile network for providing the PTT service to the calling/called terminals. The method comprises generating, by the calling terminal, a full-duplex mode request message and transmitting the full-duplex mode request message to the mobile network; transmitting, by the mobile network, the full-duplex mode request message to a PoC server that provides a PoC service to the calling terminal. The method further comprising, upon receiving the full-duplex mode request message, setting, by a PoC server of the calling terminal, the calling terminal to a full duplex mode. The full-duplex mode request message is transmitted by the PoC server of the calling terminal to a PoC server of the called terminal, and the full-duplex mode request message is transmitted by the PoC server of the called terminal to the called terminal. A call between the calling terminal and the called terminal is performed in the full duplex mode if the called terminal responds to the full-duplex mode request message.

According to another aspect of the present invention, there is provided a system for servicing a full duplex call in Push-To-Talk over cellular (PoC) in a communication system including at least two or more terminals for receiving a Push-To-Talk (PTT) service and a mobile network for providing the PTT service to the terminals. The system comprises a terminal for, if there is a PTT service request, generating a full-duplex mode request message, transmitting the full-duplex mode request message to the mobile network, and operating in a full duplex mode upon receiving a response to the full-duplex mode request message. The system further comprises a PoC server for, upon receiving the full-duplex mode request message from the terminal, setting the terminal to the full duplex mode and performing the PTT service in the full duplex mode.

### BRIEF DESCRIPTION OF THE-DRAWINGS

The above and other objects, features and advantages of the present invention will become more apparent from the following detailed description when taken in conjunction with the accompanying drawings in which like reference numerals will be understood to refer to like parts, components and structures, where:

FIG. 1 is a call flow diagram for servicing a direct call between a calling party and a called party during initial call setup in a manual answer mode in an OMA-based PoC standard network according to a first exemplary embodiment of the present invention;

FIG. 2 is a call flow diagram for servicing a direct call between a calling party and a called party during initial call setup in an automatic answer mode in an OMA-based PoC standard network according to a second exemplary embodiment of the present invention;

FIG. 3 is a flowchart illustrating an exemplary operation of a PoC server A when a PoC client A requests a call in the full duplex mode during initial call setup according to first and second exemplary embodiments of the present invention;

FIG. 4 is a call flow diagram for servicing a full duplex call in response to a user's request during a half duplex call in an OMA-based PoC standard network according to a third exemplary embodiment of the present invention;

FIGS. 5A through 5C are diagrams illustrating a Full-Duplex Mode Request message transmitted from the PoC client A to the PoC server A and a Full-Duplex Mode Response message transmitted from the PoC client B to the PoC server B according to the third exemplary embodiment of the present invention;

FIG. 6 is a flowchart illustrating an operation of a PoC server A for providing a full-duplex call mode in response to a request of a PoC client A in a half duplex call mode according to the third exemplary embodiment of the present invention;

FIG. 7 is a call flow diagram for servicing a full duplex call in the manual answer mode in an IMS-based PoC standard according to a fourth exemplary embodiment of the present invention;

FIG. 8 is a call flow diagram for servicing a full duplex call in the automatic answer mode in an IMS-based PoC standard according to a fifth exemplary embodiment of the present invention; and

FIG. 9 is a call flow diagram for servicing a full duplex call in response to a user's request during a half duplex call in an IMS-based PoC standard according to a sixth exemplary embodiment of the present invention.

### DETAILED DESCRIPTION OF EXEMPLARY EMBODIMENTS

Exemplary embodiments of the present invention will now be described in detail with reference to the annexed drawings. In the following description, a detailed description of known functions and configurations incorporated herein has been omitted for clarity and conciseness.

The present invention will be described with reference to two typical schemes of PTT service: an OMA-based PoC standard and an IMS-based PoC standard the entire contents of which are hereby incorporated by reference. The present invention will be described with reference to six exemplary embodiments by separately applying, to each of the OMA-based PoC standard and the IMS-based PoC standard, three embodiments including one embodiment for a manual answer mode, another embodiment for an automatic answer mode, and further another embodiment that switches an operation mode from a half duplex mode to a full duplex mode during a half duplex call between users in response to a user's request. A brief description will now be made of a difference between the manual answer mode and the automatic answer mode. In the manual answer mode, if a called terminal receives an Invite message from a calling terminal, it sends a response (or answer) thereto to the calling terminal, and thereafter, the calling terminal transmits media. On the contrary, in the automatic answer mode, if a called terminal receives an Invite message from a calling terminal, a PoC server of the called party automatically responds (or answers) to the calling terminal without checking whether the called terminal responds. Therefore, the calling terminal can transmit media immediately upon receiving an automatic answer confirmation.

in addition, all drawings illustrate an exemplary arrangement were calling/called terminals have successfully performed registration for PTT service.

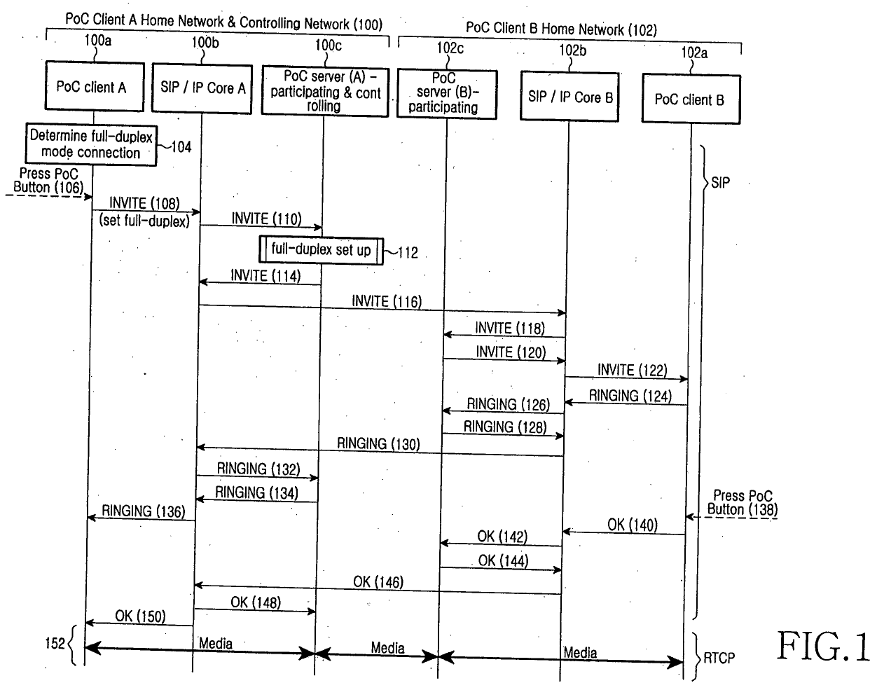

FIG. 1 is a call flow diagram for servicing a direct call between a calling party and a called party during initial call setup in a manual answer mode in an OMA-based PoC standard network according to a first embodiment of the present invention. A description of the wireless access network and unnecessary network elements will be omitted herein for clarity and conciseness.

Before a description of FIG. 1 is given, it should be noted that PoC terminals 100a and 102a, which are subscribers desiring to perform communication with PoC service, each include a PTT button for a PTT call, and can make PoC-based wireless access. In FIG. 1, Session Initiation Protocol/Internet Protocol (SIP/IP) cores 100b and 102b serve to receive PTT requests transmitted from the PoC terminals 100a and 102a and forward the PTT requests to PoC servers 100c and 102c. The PoC servers 100c and 102c, which are SIP application servers for providing PTT service, perform a core function for PTT service. The PoC servers 100c and 102c handle SIP messages in association with the SIP/IP cores 100b and 102b. That is, the PoC servers 100c and 102c serve as end points. In addition, the PoC servers 100c and 102c provide an authentication function for PTT service, and establish/release PTT sessions. Further, the PoC servers 100c and 102c handle events occurring in PTT sessions, and send a notification indicating a change in PTT session information to subscribers in each PTT service group.

A description of the nodes necessary for providing PoC service, that is constituent elements of a mobile communication network, such as a base station, a base station controller and a packet data serving node (PDSN), will be omitted herein for clarity and conciseness, because their implementation and operation will be readily understood by skilled artisans.

Prior to a description of FIG. 1, it should be noted that a first subscriber terminal requesting PTT service is defined as a PoC client A 110a and a second subscriber terminal with which the PoC client A 100a desires to perform a direct call on a 1:1 basis is defined as a PoC client B 102a. The subscriber terminals belong to different networks, and a network to which the PoC client A 100a belongs is defined as a home network A 100 while a network to which the PoC client B 102a belongs is defined as a home network B 102. Among the constituent elements, the elements with a letter ‘A’ represent elements for a calling party while the elements with a letter ‘B’ represent elements for a called party, and each subscriber terminal is directly connected to the home network.

If a calling party determines to perform a call in a full duplex mode in step 104 and pushes a PTT button to request PoC service in step 106, a PoC client A 100a transmits an Invite message, which is set to the full duplex mode in step 104, to the SIP/IP core A 100b in step 108.

In step 108, the PoC client A 100a sets a particular parameter among information elements (IEs) of the Invite message transmitted to make a full duplex direct call to a PoC client B 102a, before transmitting the Invite message. The IEs of the Invite message include:

a. A list of PoC Address of invited PoC users (1 user for direct call),

b. Media parameters of PoC client A,

c. PoC service indication,

d. PoC Address of the PoC user at the PoC client A,

e. Optionally, a manual answer override request, and

f. Talk burst control protocol proposal.

An exemplary embodiment of the present invention sets the particular parameter using ‘Talk Burst Control Protocol Proposal (TBCP)’ among the IEs in the following method.

An exemplary embodiment of the present invention uses Session Description Protocol (SDP) extensions of the Invite message transmitted with an SIP protocol. For example, TBCP MIME Registration is used as defined in OMA-TS-POC-ControlPlane-V1_{—}0-20041117-D.C.3 section. This sets the parameter using SDP a-line, and an a-line format described in RFC 2327 is as follows.

a=<attribute>:<value>

An SIP SDP message includes various attributes, and each of the attributes defines an attribute of a corresponding message. In addition, each attribute is distinguished with a preset value.

In the general half duplex, the value is set to ‘Lock’, and in an embodiment of the present invention, the PoC client A 100a sets the value to ‘unlock’ before transmitting the Invite message to the SIP/IP core A 100b, as follows:

a=poc-lock:lock

a=poc-lock:unlock

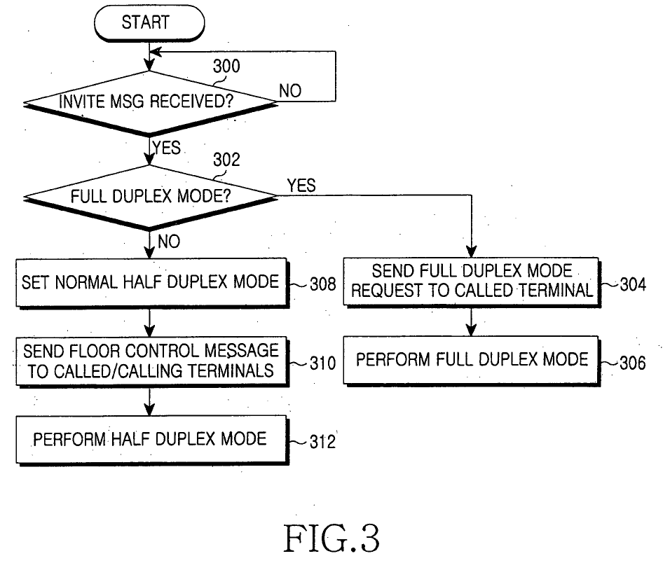

Thereafter, the SIP/IP core A 100b transmits an Invite message to a PoC server A 100c in step 110, and the PoC server A 100c can perform a full duplex communication procedure with the PoC client B 102a which is a called terminal, in step 112. An operation of the procedure will be described in detail later with reference to FIG. 3.

Steps 114 through 122 correspond to a process in which the PoC client A 100a, which is a calling terminal, transmits an Invite message for call setup for a direct call with the PoC client B 102a, which is a called terminal, and a detailed description thereof will be omitted because it is described in the PoC standard.

Upon receiving the Invite message in step 122, the PoC client B 102a transmits in step 124 a Ring signal indicating correct receipt of the Invite message to an SIP/IP core B 102b and informs the called party of receipt of the Invite message for operating in the full duplex mode. Steps 124 through 136 correspond to a process of transmitting a Ring signal to the PoC client A 100a, and a detailed description thereof will be omitted because it is described in the PoC standard. In step 138, the called party determines to set up a PTT call, accepting the invite from the calling party, and pushes a corresponding button in response thereto.

In step 140, the PoC client B 102a transmits an OK message in response to the received Invite message. Thereafter, steps 142 through 150 correspond to a process of transmitting the OK message to the PoC client A 100a, and a description of a corresponding signal flow between network elements will be omitted because it is also described in the PoC standard. Upon receiving the OK message in step 150, the PoC client A 100a forms an RTCP channel through which it can exchange media with the PoC client B 102a. In step 152, the PoC client A 100a transmit media in the full duplex mode, performing a direct call. Herein, the term “media” refers to voice and image data, and is transmitted over a bearer channel.

The messages are transmitted using the SIP protocol in steps 108 through 150, and transmitted using the RTCP protocol in step 152.

As described with reference to FIG. 1, unlike the general half duplex scheme, in exemplary implementations of the present invention transmission and reception can be achieved simultaneously without the need to acquire a floor between the calling party and the called party.

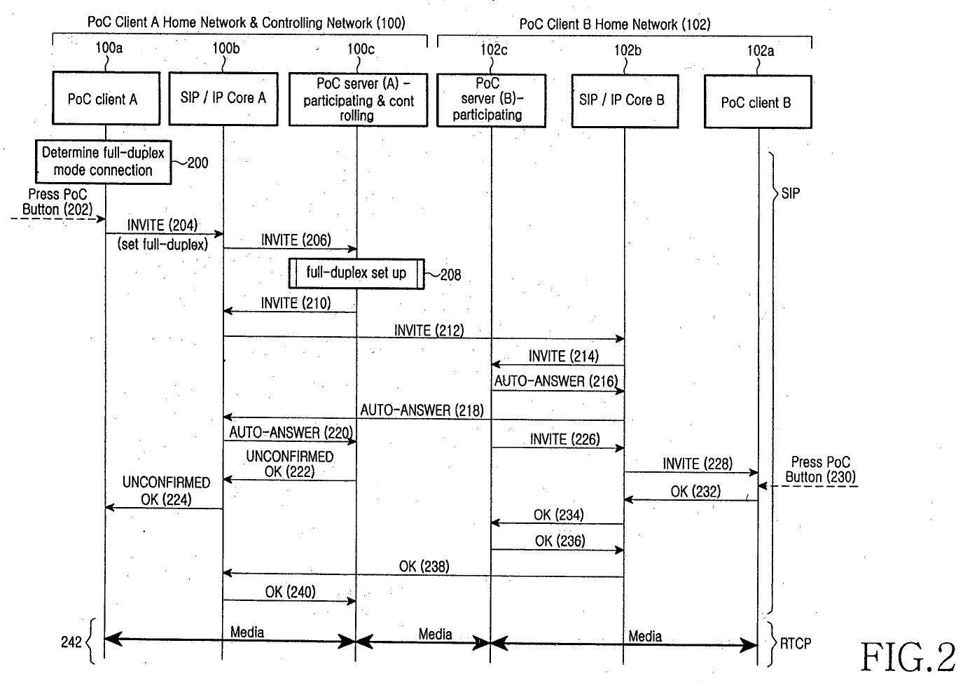

FIG. 2 is a call flow diagram for servicing a direct call between a calling party and a called party during initial call setup in an automatic answer mode in an OMA-based PoC standard network according to a second embodiment of the present invention. A description of each wireless access network and unnecessary network elements will be omitted herein for simplicity. As described with reference to FIG. 1, it should be noted that a first subscriber terminal requesting PTT service is defined as a PoC client A 110a and a second subscriber terminal with which the PoC client A 100a desires to perform a direct call on a 1:1 basis is defined as a PoC client B 102a. The subscriber terminals belong to different networks, and a network to which the PoC client A 100a belongs is defined as a home network A 100 while a network to which the PoC client B 102a belongs is defined as a home network B 102. Among the constituent elements, the elements with a letter ‘A’ represent elements for a calling party while the elements with a letter ‘B’ represent elements for a called party, and each subscriber terminal is directly connected to the home network.

In order to operate in the automatic answer mode, the PoC client B 102a should preferentially perform a process of registering itself in a PoC server B 102c so as to operate in the automatic answer mode.

If a calling party determines to perform a call in a full duplex mode in step 200 and pushes a PTT button to request PoC service in step 202, a PoC client A 100a transmits an Invite message, which is set to the full duplex mode in step 200, to an SIP/IP core A 100b in step 204.

In step 204, the PoC client A 100a sets a particular parameter among IEs of the Invite message transmitted to make a full duplex direct call to a PoC client B 102a, before transmitting the Invite message. The IEs of the Invite message include:

a. A list of PoC Address of invited PoC users (1 user for direct call),

b. Media parameters of PoC client A,

c. PoC service indication,

d. PoC Address of the PoC user at the PoC client A,

e. Optionally, a manual answer override request, and f. Talk burst control protocol proposal.

An exemplary embodiment of the present invention sets the particular parameter using ‘Talk Burst Control Protocol Proposal (TBCP)’ among the IEs in the following method.

TBCP MIME Registration is used as defined in OMA-TS-POC-ControlPlane-V1_{—}0-20041117-D.C.3 section. This sets the parameter using SDP a-line, and an a-line format described in RFC 2327 is as follows.

a=<attribute>:<value>

An SIP SDP message includes various attributes, and each of the attributes defines an attribute of a corresponding message. In addition, each attribute is distinguished with a preset value.

In the general half duplex, the value is set to ‘Lock’, and in an embodiment of the present invention, the PoC client A 100a sets the value to ‘unlock’ before transmitting the Invite message to the SIP/IP core A 100b, as follows:

a=poc-lock:lock

a=poc-lock:unlock

Thereafter, the SIP/IP core A 100b transmits an Invite message to a PoC server A 100c in step 206, and the PoC server A 100c can perform a full duplex communication procedure with the PoC client B 102a which is a called terminal, in step 208. An operation of the procedure will be described in detail later with reference to FIG. 3.

Steps 210 through 214 correspond to a process in which the PoC client A 100a, which is a calling terminal, transmits an Invite message for call setup for a direct call with the PoC client B 102a, which is a called terminal, and a detailed description thereof will be omitted because it is described in the PoC standard.

In the PoC server B 102c that received the Invite message in step 214, the PoC client B 102a preferentially performed the process of registering itself in the PoC server B 102c so as to operate in the automatic answer mode. Therefore, upon receiving the Invite message, the PoC server B 102c transmits an automatic answer (Auto-Answer) message to an SIP/IP core B 102b in step 216. Steps 216 through 224 correspond to a process of transmitting an Auto-Answer message to the PoC client A 100a that requested the PTT service, and a detailed description thereof will be omitted because it is also described in the PoC standard.

After transmitting the Auto-Answer message in step 216, the PoC server B 102c transmits an Invite message to the SIP/IP core B 102b in step 226, and the SIP/IP core B 102b transmits an Invite message to the PoC client B 102a in step 228 to perform call setup for a direct call to the called party.

In step 230, the called party, if he/she desires a direct call with the calling party, pushes a PTT button to allow the PoC client B 102a to answer to the Invite message. In step 232, the PoC client B 102a transmits an OK message indicating acceptance of the received Invite message to the SIP/IP core B 102b. Thereafter, the SIP/IP core B 102b transmits the OK message up to the PoC server A 100c with the SIP protocol through steps 234 through 240. Because the PoC client A 100a received the OK message in step 224, the PoC server A 100c does not need to transmit the OK message to the PoC client A 100a.

In step 242, the PoC client A 100a performs a 1:1 direct call with the PoC client B 102a on a full duplex basis.

As described with reference to FIG. 2, unlike the general half duplex scheme, the present invention can simultaneously perform transmission and reception without the need to acquire a floor between the calling party and the called party.

FIG. 3 is a flowchart illustrating an operation of a PoC server A 100c when a PoC client A 100a requests a call in the full duplex mode during initial call setup according to first and second embodiments of the present invention.

A PoC server A 100c determines in step 300 whether an Invite message is received from an SIP/IP core A 100b. Upon receipt of the Invite message in step 300, the PoC server A 100c determines in step 302 whether a particular parameter among IEs of the received Invite message is set to full duplex.

The IEs of the Invite message includes:

a. A list of PoC Address of invited PoC users (1 user for direct call),

b. Media parameters of PoC client A,

c. PoC service indication,

d. PoC Address of the PoC user at the PoC client A,

e. Optionally, a manual answer override request, and

f. Talk burst control protocol proposal.

An exemplary embodiment of the present invention sets the particular parameter using ‘Talk Burst Control Protocol Proposal (TBCP)’ among the IEs in the following method.

TBCP MIME Registration is used as defined in OMA-TS-POC-ControlPlane-V1_{—}0-20041117-D.C.3 section. This sets the parameter using SDP a-line, and an a-line format described in RFC 2327 is as follows.

a=<attribute>:<value>

In the general half duplex, the value is set to ‘Lock’, and in an embodiment of the present invention, the PoC client A 100a sets the value to ‘unlock’.

Therefore, in an exemplary embodiment of the present invention, if the PoC server A 100c determines that the ‘value’ of the SDP a-line is set to ‘unlock’, it can recognize that the PoC client A 100a desires perform a call with the PoC client B 102a in the full duplex mode.

Upon detecting the setting of the full duplex in step 302, the PoC server A 100c proceeds to step 304 where it sends a request for an operation in the full duplex mode to the PoC client B 102a which is a called terminal. In step 306, the PoC server A 100c performs a call between the PoC client A 100a and the PoC client B 102a in the full duplex mode, without performing a floor control procedure.

On the contrary, if the particular parameter among the IEs of the received Invite message is not set to the full duplex mode in step 302, the PoC server A 100c sets the particular parameter to the general PTT service, that is, the half duplex mode in step 308, and transmits a Floor Control message to called/calling terminals in step 310. As a result, the PoC server A 100c operates in the general half duplex mode in step 312.

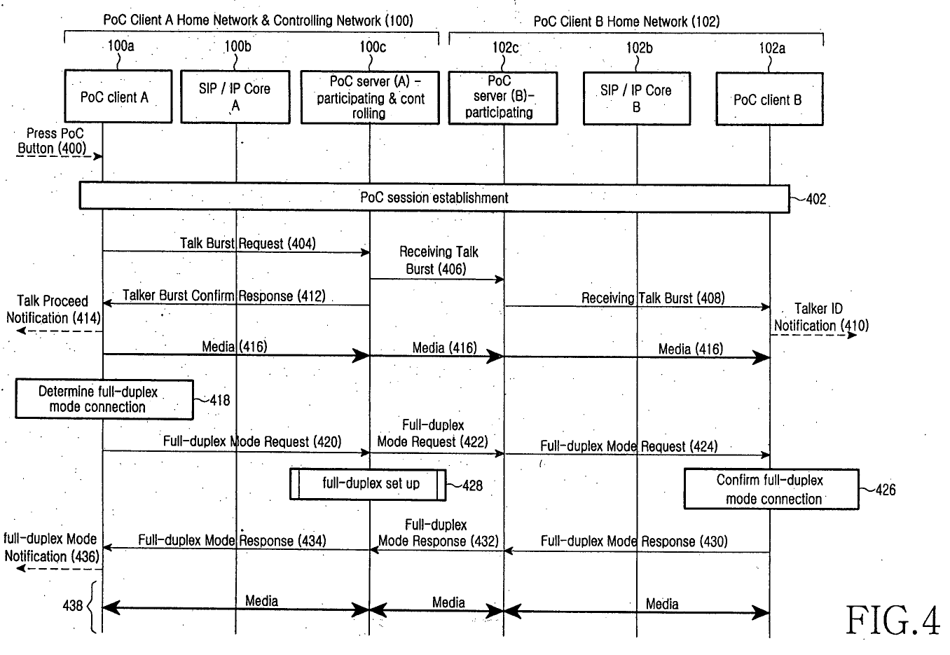

FIG. 4 is a call flow diagram for servicing a full duplex call in response to a user's request during a half duplex call in an OMA-based PoC standard network according to a third embodiment of the present invention.

As a calling party pushes a PTT button in step 400, a PoC client A 100a sets up a call for PTT service to an SIP/IP core A 100b. Then, a PoC session between the PoC client A 100a and a PoC client B 102a is established in step 402. If the PoC client A 100a, which is a calling terminal, transmits a Talk Burst Request message for requesting a floor, to a PoC server A 100c with a RTCP protocol in step 404, the PoC server A 100c transmits a Receiving Talk Burst message to a PoC server B 102c for the called party in step 406 to inform the PoC client B 102a that the PoC client A 100a has a floor. The PoC server B 102c transmits the Receiving Talk Burst message to the PoC client B 102a in step 408, and informs the PoC client B 102a in step 410 that a calling terminal having the floor is the PoC client A 100a.

Upon receiving the Talk Burst Request message, the PoC server A 100c delivers a Talker Burst Confirm Response message to the PoC client A 100a in step 412. Then the PoC client A 100a notifies the acquisition of the floor to the calling party in step 414, and transmits media to the PoC client B 102a in step 416. A process of notifying the acquisition of the floor to the calling party in step 414 can be performed in a predetermined method of, for example, outputting the corresponding information on a display of the PoC client A 100a to allow the calling party to perceive the information. Steps 400 through 416 correspond to the general floor control procedure defined in the PoC standard, so a detailed description thereof will be omitted herein for clarity and conciseness.

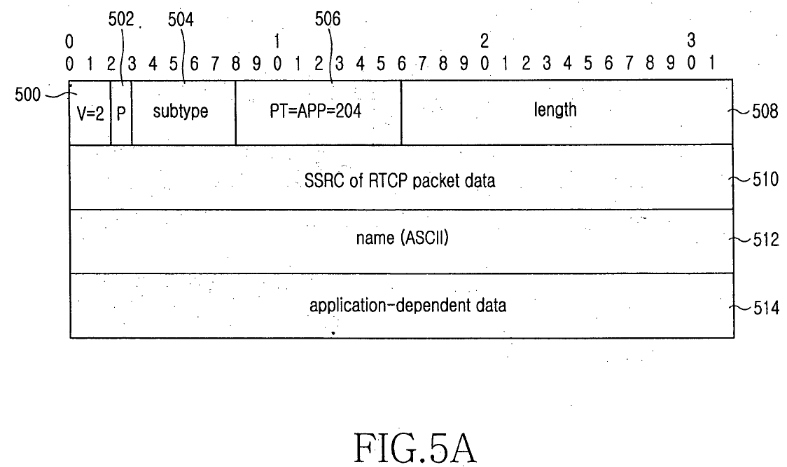

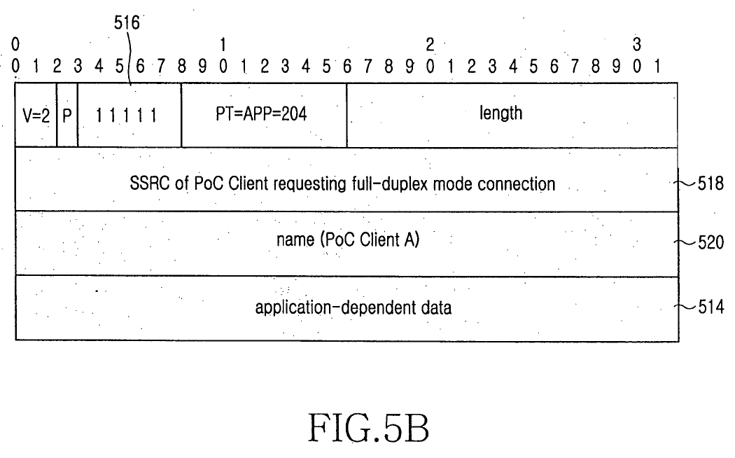

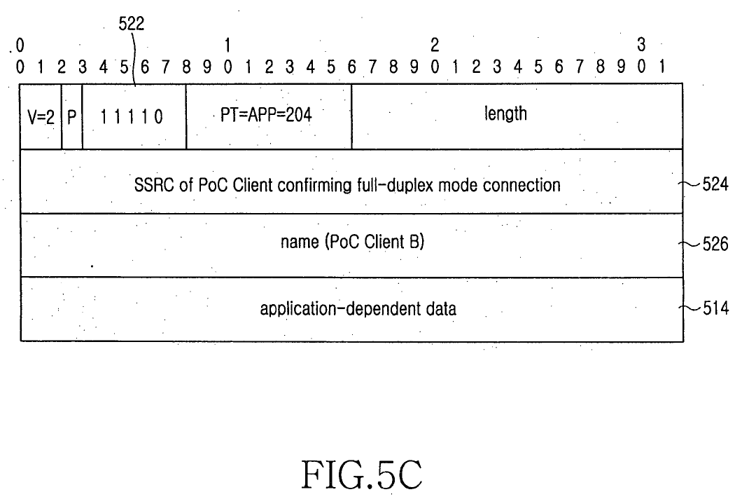

On the contrary, if the calling party desires a direct call to the called party in the full duplex mode in step 418, he/she pushes a corresponding button of the PoC client A 100a. Then the PoC client A 100a transmits a Full-Duplex Mode Request message to the PoC server A 100c in step 420. The PoC server A 100c transmits the Full-Duplex Mode Request message to the PoC server B 102c in step 422, and the PoC server B 102c forwards the Full-Duplex Mode Request message to the PoC client B 102a in step 424. Herein, the Full-Duplex Mode Request message transmitted by the PoC client A 100a can use the RTCP or SIP protocol, and in an exemplary embodiment of the present invention, it will be described for the RTCP protocol with reference to FIGS. 5A through 5C.

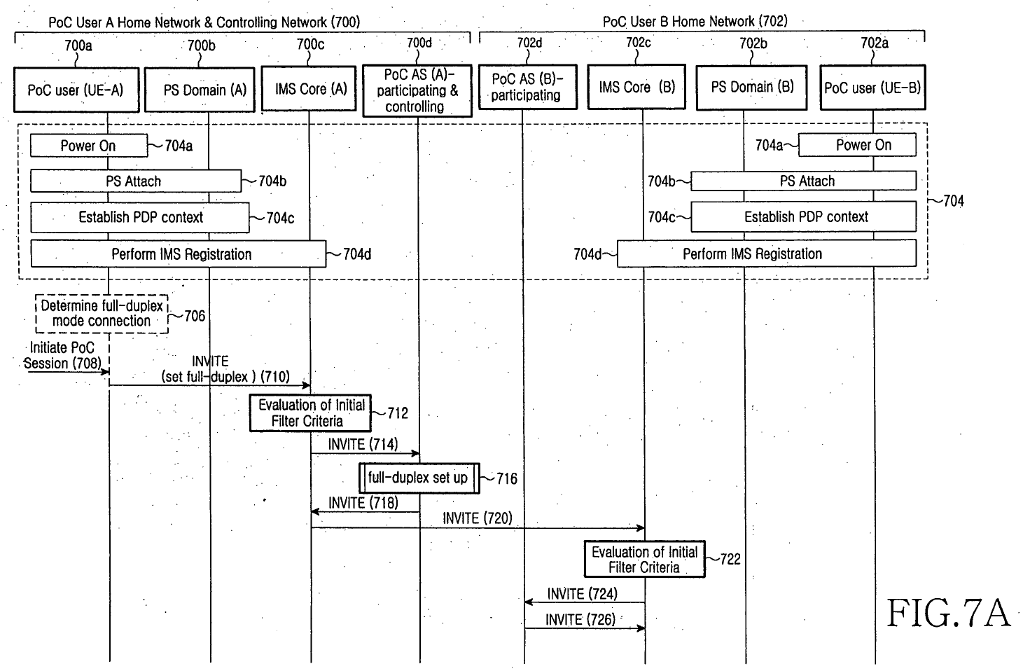

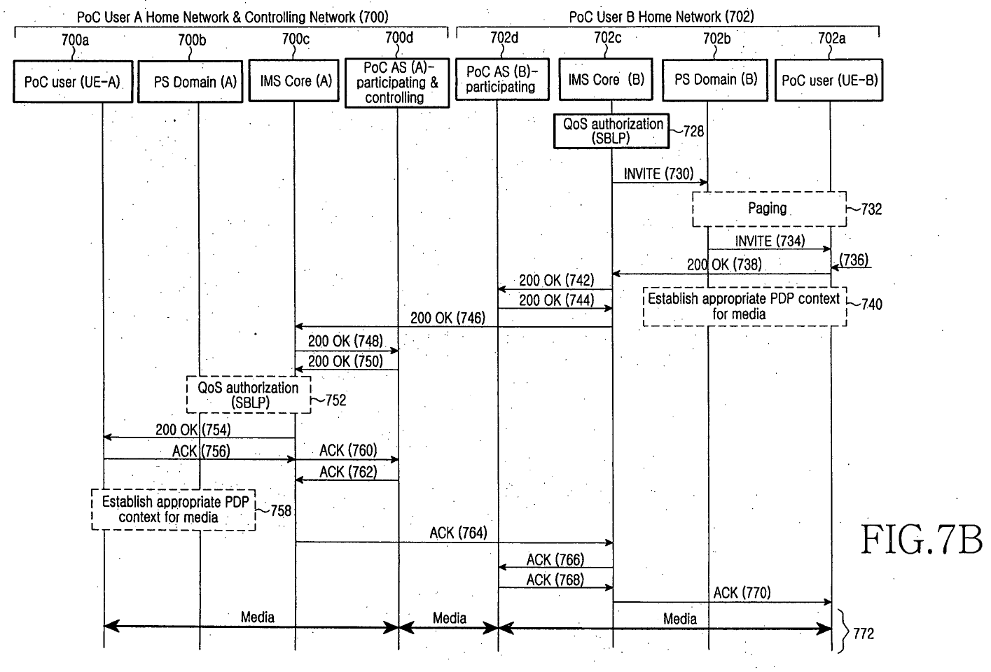

Upon receiving the Full-Duplex Mode Request message, the PoC client B 102a notifies the calling party's request for the full duplex to the called party in step 426, and the called party pushes a corresponding button of the PoC client B 102a. The PoC server A 100c performs an operation for setting the full duplex mode in step 428, and a description thereof will be made later with reference to FIG. 7.

The PoC-client B 102a transmits a Full-Duplex Mode Response message to the PoC server B 102c in step 430. The PoC server B 102c transmits the Full-Duplex Mode Response message to the PoC server A 100c in step 432, and the PoC server A 100c transmits the Full-Duplex Mode Response message to the PoC client 100a in step 434. The Full-Duplex Mode Response message transmitted in step 430 by the PoC client B 102a will be described later with reference to FIGS. 5A through 5C. The calling party perceives in step 436 that the called party has requested the full duplex mode, and the PoC client A 100a of the calling party can communicate with the PoC client B 102a in the full duplex mode in step 438.

In FIG. 4, all processes except for the simplified process of step 402 use the RTCP protocol, so their associated messages do not pass through SIP/IP cores 100b and 102b and have different formats. However, the Full-Duplex Mode Request message is transmitted not necessarily with the RTCP protocol, but can occasionally be transmitted with the SIP protocol. An embodiment of the present invention will be described on the assumption that the RTCP protocol is used for the Full-Duplex Mode Request and Response messages. With reference to FIGS. 5A through 5C, a description will now be made of the Full-Duplex Mode Request message transmitted in step 420 by the PoC client A 100a and the Full-Duplex Mode Request Response message transmitted in step 430 by the PoC client B 102a.

FIGS. 5A through 5C are diagrams illustrating a Full-Duplex Mode Request message transmitted from the PoC client A 100a to the PoC server A 100c and a Full-Duplex Mode Response message transmitted from the PoC client B 102a to the PoC server B 102c according to the third embodiment of the present invention. An embodiment of the present invention sets a particular parameter of an RTCP message format defined in RFC 3550 and OMA-TS_PoC-UserPlaneV1_{—}0-20050112-D (Section 6.5.1) the entire contents of which are hereby incorporated by reference.

A brief description will now be made of an RTCP message format shown in FIG. 5A. A header of an RTCP packet has a fixed size, and has particular information and data attached to its end according to multimedia information. Reference numeral 500 means that an RTCP version is 2.0 (V=2), and reference numeral 502 represents a field used for generating a packet in units of 32 bits. Reference numeral 504 represents a subtype, and is a part that is set when the PoC client A 100a transmits the Full-Duplex Mode Request message or when the PoC client B 102a transmits the Full-Duplex Mode Response message according to an exemplary embodiment of the present invention. Reference numeral 508 represents a length of the RTCP message, and reference numeral 510 represents an identifier of a Synchronization Source (SSRC) of the RTCP packet data. Reference numeral 512 represents a terminal that sent the message, and reference numeral 514 represents a field for storing additional data.

FIG. 5B is a diagram illustrating a format of the Full-Duplex Mode Request message transmitted by the PoC client A 100a according to an embodiment of the present invention. It can be noted that the message format is different from that of FIG. 5A in that the fields represented by reference numerals 516, 518 and 520 are set to different values. In an embodiment of the present invention, upon detecting that the subtype field 504 in the RTCP message received from the PoC client A 100a is set to ‘11111’ as shown by reference numeral 516, the PoC server A 100c sends a full duplex mode request to the PoC client B 102a, which is a called terminal, skipping the floor control procedure. Although the subtype field 504 in the RTCP message format has been used herein, the Full-Duplex Mode Request message can also be transmitted using another unused field.

A field represented by reference numeral 518 is used for storing SSRC of the PoC client that requested the full-duplex mode connection, and a field represented by reference numeral 520 is used for storing a name of the PoC client A 100a, which is a terminal that transmitted the Full-Duplex Mode Request message.

FIG. 5C is a diagram illustrating a format of the Full-Duplex Mode Response message transmitted from the PoC client B 102a to the PoC server B 102c according to an embodiment of the present invention. It can be noted that the message format shown in FIG. 5A is different from the message format of FIG. 5C in terms of the fields represented by reference numerals 522, 524 and 526. In an exemplary embodiment of the present invention, the PoC client B 102a modifies the subtype field to ‘11110’ represented by reference numeral 522 before transmitting the Full-Duplex Mode Response message with the RTCP protocol type to the PoC server B 102c. A field represented by reference numeral 524 is used for storing SSRC of a PoC client that detected the full duplex mode connection, and a field represented by reference numeral 526 is used for storing a name of the PoC client B 102a, which is a terminal that transmitted the Full-Duplex Mode Response message.

Although an exemplary embodiment of the present invention has set the subtype field 504 of the RTPC protocol to a particular value for both the Full-Duplex Mode Request message and the Full-Duplex Mode Response message, it is also possible to set the particular value using another unused field.

In FIG. 3, when a calling party desires to perform a call in the general half duplex mode, the calling party sets a particular value in the RTCP message before transmitting the RTCP message to the PoC server A 100c. In this case, an exemplary embodiment of the present invention sets the subtype field 504 to ‘00000’ before transmission.

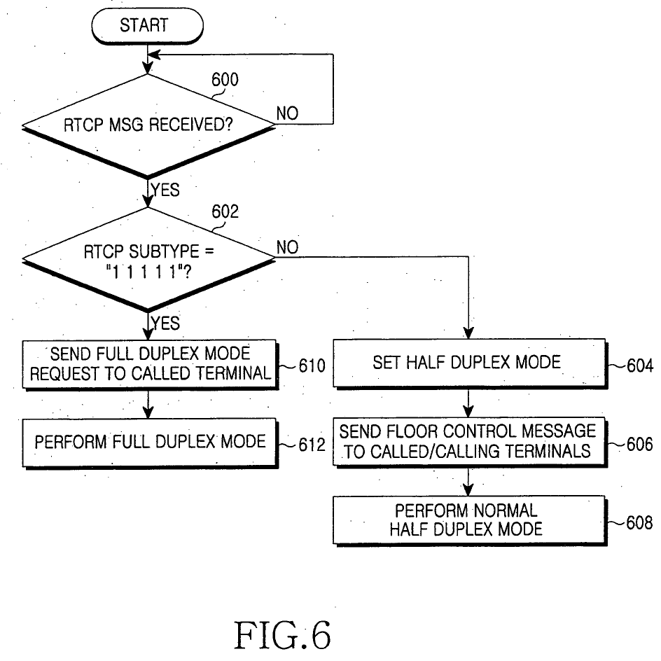

FIG. 6 is a flowchart illustrating an operation of a PoC server A 100c for providing a full-duplex call mode in response to a request of a PoC client A 100a in a half duplex call mode according to the third embodiment of the present invention.

A PoC server A 100c determines in step 600 whether an RTCP message is received from a PoC client A 100a. If the RTCP message is received in step 600, the PoC server A 100c determines in step 602 whether a subtype field 504 of the RTCP message is set to ‘11111’. If the subtype field 504 is set to ‘11111’ in step 602, the PoC server A 100c proceeds to step 610 where it sends a request for an operation in the full duplex mode to a PoC client B 102a, which is a called terminal. The PoC server A 100c operates in the full duplex mode in step 612.

Although an exemplary embodiment of the present invention has set the subtype field 504 of the RTCP format to a particular value in creating the Full-Duplex Mode Request message, it is also possible to set the particular value using another unused field.

However, if the subtype field 504 is set to ‘11111’ in step 602, the PoC server A 100c sets a general half duplex mode in step 604. The PoC server A 100c delivers a Floor Control message to the PoC client A 100a which is a calling terminal and the PoC client B 102a which is a called terminal in step 606, to control the floor, and performs the general half duplex mode in step 608.

An exemplary embodiment of the present invention has been described so far based on the PoC standard defined in the OMA. An exemplary embodiment of the present invention will now be described based on the IMS-based PoC standard. A general IMS-based PTT call flow is defined in 3GPP TR 23.979 v2.0.0 (2004-11) the entire contents of which are hereby incorporated by reference, so a detailed description thereof will be omitted herein. It will be assumed that both a calling terminal and a called terminal have completed a registration procedure for receiving PTT service.

FIGS. 7A and 7B set forth a call flow diagram for servicing a full duplex call in the manual answer mode in an IMS-based PoC standard according to a fourth exemplary embodiment of the present invention. Before a description of FIGS. 7, 8 and 9 is given, it will be assumed that PoC subscriber terminals 700a and 702a desiring to perform communication with PoC service each include a PTT button for performing a PTT call, and can make a radio access according to the IMS-based PoC standard.

Packet switched (PS) domains 700b and 702b described below with reference to FIGS. 7A, 7B, 8A, 8B, 9A and 9B are equal to the PS domains defined in the Wideband-Code Division Multiple Access (W-CDMA) standard the entire contents of which are hereby incorporated by reference. A W-CDMA core network is divided into circuit switched (CS) domain equipments constituting a CS network and PS domain equipments constituting a PS network according to their constituent attributes. PoC service is connected via the PS network, and the PS domain equipments include a Serving GPRS (General Packet Radio Service) Support Node (SGSN) and a Gateway GPRS Support Node (GGSN).

These equipments perform authentication, mobility management and call processing functions for subscriber terminals through interfacing between a W-CDMA radio access network (RAN) system and an external network (Internet-based public network, other carrier's wireless network, and private network), aiming at providing an environment in which a subscriber can enjoy not only the telephone service but also various multimedia service through Internet access even while on the move.

IP Multimedia Subsystem (IMS) cores 700c and 702c each are a system that provides similar functions to those of the SIP/IP core among PoC systems, and can implement a Call State Control Function (CSCF) in the IMS system. Generally, the functions provided for PoC service in the IMS core include:

routing SIP signaling between PoC subscriber terminal and PoC Application Server (AS),

providing discovery and address resolution services,

providing SIP compression, if needed,

performing authentication and authorization based on service profile of PoC subscriber terminal, and

performing registration.

PoC ASs 700d and 702d each are a system that provides similar functions to those of a PoC server among PoC systems, and generally provide the following functions:

PoC session handling,

Media distribution and relay,

floor control and relay,

SIP session handling,

policy enforcement for participants in a group session, and

participant information providing.

Before a description of FIGS. 7A and 7B is given, it should be noted that a first subscriber terminal requesting PTT service is defined as a PoC user A 700a and a second subscriber terminal with which the PoC user A 700a desires to perform a direct call on a 1:1 basis is defined as a PoC user B 702a. The subscriber terminals belong to different networks, and a network to which the PoC user A 700a belongs is defined as a home network A 700 while a network to which the PoC user B 702a belongs is defined as a home network B 702. In addition, the constituent elements with a letter ‘A’ represent elements for a calling party, while the constituent elements with a letter ‘B’ represent elements for a called party.

In step 704, a PoC user A 700a and a PoC user B 702a should complete a registration process for using PTT service in the following procedure. Each of the users, that is, the PoC subscriber terminal A 700a and the PoC Subscriber terminal B 702a, powers ON the terminal in step 704a, registers itself in its associated one of PS domain systems (SGSN and GGSN) 700b and 702b in step 704b, establishes a Packet Data Protocol (PDP) context between the PoC subscriber terminal and the GGSN in step 704c, and finally performs an IMS registration process in step 704d, completing the registration process for PTT service. A detailed description of the foregoing procedure is disclosed in 3GPP TS 23.060 standard the entire contents of which are hereby incorporated by reference. Although the sub-processes of the registration process are denoted by the same reference numeral 704 in FIGS. 7A and 7B, they may be performed at different times.

After the registration process of step 704, the calling party determines to perform a call with the called terminal in the full duplex mode in step 706. If the calling party pushes a PTT button to request PoC service in step 708, the PoC subscriber terminal A 700a transmits an Invite message to an IMS core A 700c in step 710. Upon receiving the Invite message, the IMS core A 700c searches a service profile of the PoC subscriber terminal A 700a in step 712, and transmits the Invite message to a PoC AS A 700d in step 714. In step 710, the PoC subscriber terminal A 700a sets a particular parameter among IEs of the Invite message before transmission.

The IEs of the Invite message include:

a. A list of PoC Address of invited PoC users (1 user for direct call),

b. Media parameters of PoC client A,

c. PoC service indication,

d. PoC Address of the PoC user at the PoC client A,

e. Optionally, a manual answer override request, and

f. Talk burst control protocol proposal.

An exemplary embodiment of the present invention sets the particular parameter using ‘Talk Burst Control Protocol Proposal (TBCP)’ among the IEs in the following method.

TBCP MIME Registration is used as defined in OMA-TS-POC-ControlPlane-V1_{—}0-20041117 (Section D.C.3) the entire contents of which are hereby incorporated by reference. This sets the parameter using SDP a-line, and an a-line format described in RFC 2327 is as follows.

a=<attribute>:<value>

In the general half duplex, the value is set to ‘Lock’, and in an embodiment of the present invention, the PoC user A 700a sets the value to ‘unlock’ before transmitting the Invite message to the IMS core A 700c.

Upon receiving the Invite message, the PoC AS A 700d can perform a procedure for a full duplex call with the PoC subscriber terminal B 702a, which is a called terminal, in step 716, and a description of the procedure has been described with reference to FIG. 3.

The PoC AS A 700d transmits the Invite message to the IMS core A 700c in step 718, and the IMS core A 700c transmits the Invite message to an IMS core B 702c in step 720. The IMS core B 702c searches a service profile of the PoC subscriber terminal B 702a, which is the called terminal, in step 722, and transmits the Invite message to a PoC AS B 702d in step 724. The PoC AS B 702d transmits the Invite message to the IMS core B 702c in step 726, and the IMS core B 702c performs Quality-of-Service (QoS) authentication in step 728, and transmits the Invite message to a PS domain B 702b in step 730.

Upon receiving the Invite message in step 730, the PS domain B 702b pages the PoC subscriber terminal B 702a, which is the called terminal, in step 732, and transmits an Invite message to the PoC subscriber terminal B 702a in step 734. Upon receiving the Invite message, the PoC subscriber terminal B 702a determines in step 736 whether to respond (answer) to the Invite message, and transmits a 200 OK message to the IMS core B 702c in a manual answer mode in step 738 according to an embodiment of the present invention. Thereafter, in step 740, the PS domain B 702b and the PoC subscriber terminal B 702a establish a PDP context appropriate for media in step 740.

The IMS core B 702c transmits the 200 OK message to the PoC AS B 702d in step 742, and the PoC AS B 702d transmits the 200 OK message back to the IMS core B 702c in step 744. The IMS core B 702c transmits the 200 OK message to the IMS core A 700c in step 746. The IMS core A 700c transmits the 200 OK message to the PoC AS A 700d in step 748, and the PoC AS A 700d transmits the 200 OK message back to the IMS core A 700c in step 750. The IMS core A 700c and the PS domain A 700b perform QoS authentication in step 752, and the IMS core A 700c transmits the 200 OK message to the PoC subscriber terminal A 700a in step 754.

Upon receiving the 200 OK message, the PoC subscriber terminal A 700a transmits an ACK message to the IMS core A 700c in response thereto in step 756. The PoC subscriber terminal A 700a and the PS domain A 700b establish a PDP context appropriate for media in step 758, and the IMS core A 700c transmits the ACK message to the PoC AS A 700d in step 760. The PoC AS A 700d transmits the ACK message to the IMS core A 700c in step 762, and the IMS core A 700c transmits the ACK message to the IMS core B 702c in step 764. The IMS core B 702c transmits the received ACK message to the PoC AS B 702d in step 766, and the PoC AS B 702d transmits the ACK message back to the IMS core B 702c in step 768. The IMS core B 702c transmits the ACK message to the PoC subscriber terminal B 702a in step 770, and the PoC subscriber terminal A 700a and the PoC subscriber terminal B 702a perform a call in the full duplex mode in step 772.

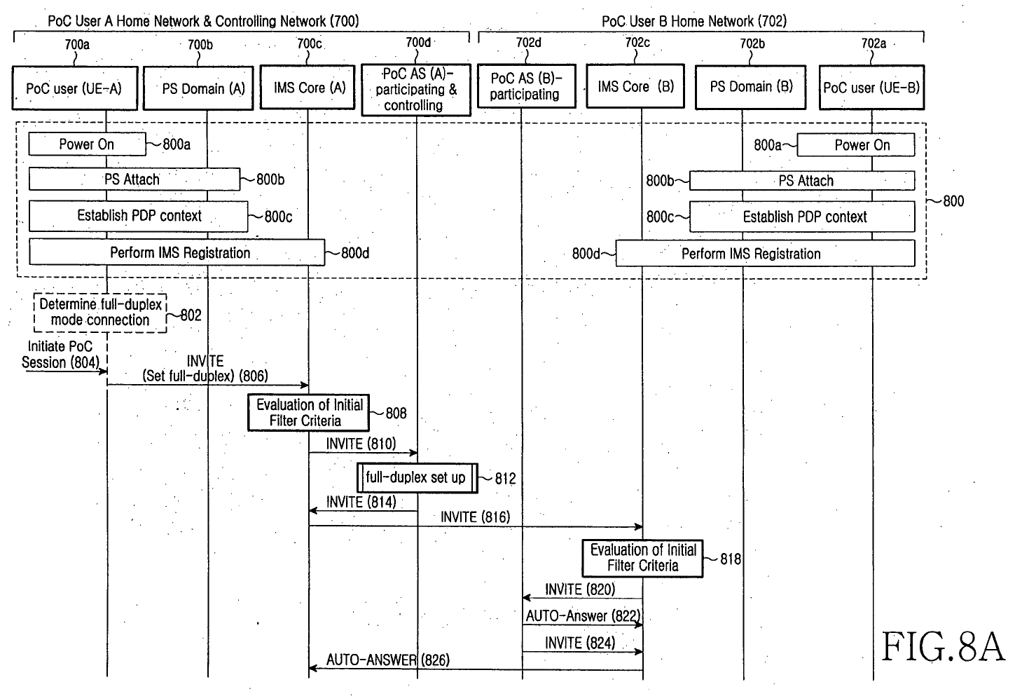

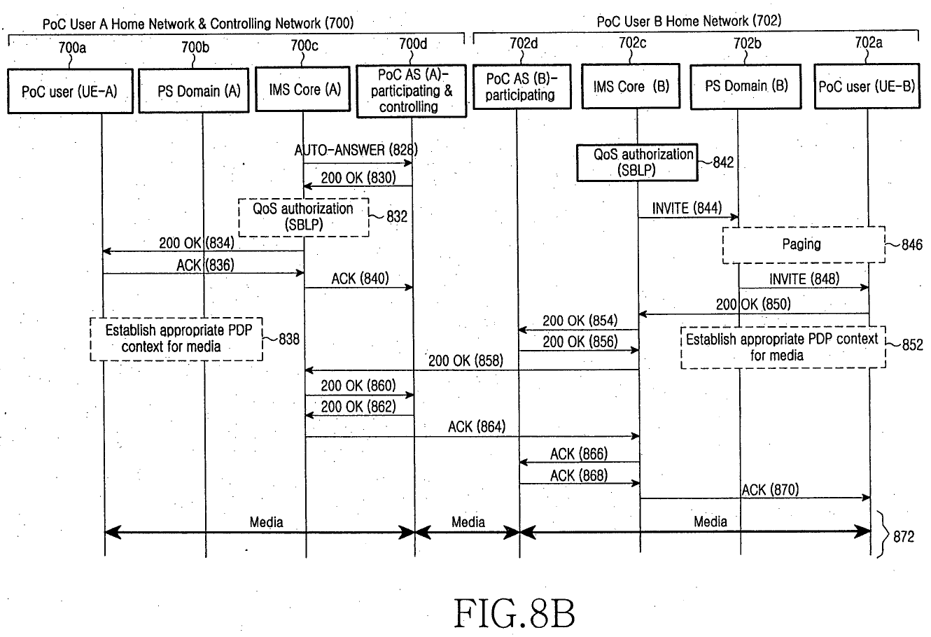

The operation of servicing a full duplex call in the manual answer mode in the IMS-based PoC system according to the fourth exemplary embodiment of the present invention has been described above. With reference to FIGS. 8A and 8B, a description will now be made of an exemplary operation of the PoC subscriber terminal B 702a in the automatic answer mode rather than the manual answer mode.

FIGS. 8A and 8B set forth a call flow diagram for servicing a full duplex call in the automatic answer mode in an IMS-based PoC standard according to a fifth exemplary embodiment of the present invention. Before a description of FIG. 8 is given, it is noted that a PoC subscriber terminal B 702a should preferentially perform a process of previously registering itself in a PoC AS B 702d so as to operate in the automatic answer mode.

PS domains 700b and 702b, IMS cores 700c and 702c, and PoC ASs 700d and 702d in FIGS. 8A and 8B have been described with reference to FIGS. 7A and 7B, so a detailed description thereof will be omitted herein.

In step 800, a PoC user A 700a and a PoC user B 702a should complete a registration process for using PTT service in the following procedure. Each of the users, that is, the PoC subscriber terminal A 700a and the PoC Subscriber terminal B 702a, powers ON the terminal in step 800a, registers itself in its associated one of PS domain systems 700b and 702b in step 800b, establishes a PDP context in step 800c, and finally performs IMS registration in step 800d, completing the registration process for PTT service.

After the registration process is successfully completed in step 800, the calling party determines to perform a call with the called terminal in the full duplex mode in step 802. Thereafter, if the calling party pushes a PTT button of the PoC subscriber terminal A 700a to request PoC service in step 804, the PoC subscriber terminal A 700a transmits an Invite message to an IMS core A 700c in step 806. Upon receiving the Invite message, the IMS core A 700c searches a service profile of the calling subscriber in step 808, and transmits the Invite message to a PoC AS A 700d in step 810. In step 806, the PoC subscriber terminal A 700a sets a particular parameter among IEs of the Invite message before transmission, and this process is equal to that performed in step 710 of FIGS. 7A and 7B, so a description thereof will be omitted.

Upon receiving the Invite message, the PoC AS A 700d can perform a procedure for a full duplex call with the PoC subscriber terminal B 702a, which is a called terminal, in step 812, and a description of the procedure has been described with reference to FIG. 3.

The PoC AS A 700d transmits the Invite message to the IMS core A 700c in step 814, and the IMS core A 700c transmits the Invite message to an IMS core B 702c in step 816. The IMS core B 702c searches a service profile of the PoC subscriber terminal B 702a, which is the called terminal, in step 818, and transmits the Invite message to a PoC AS B 702d in step 820. Then the PoC AS B 702d transmits an Auto-Answer message to the PoC subscriber terminal A 700a which is the called terminal in response to the received Invite message, as it is set to operate in the automatic answer mode.

Therefore, the PoC AS B 702d transmits the Auto-Answer message to the IMS core B 702c in step 822, and transmits the Invite message, received in step 820, to the IMS core B 702c in step 824. Upon receiving the Auto-Answer message in step 822, the IMS core B 702c transmits the Auto-Answer message to the IMS core A 700c in step 826. The IMS core A 700c transmits the Auto-Answer message to the PoC AS A 700d in step 828, and the PoC AS A 700d transmits a 200 OK message to the IMS core A 700c in response to the Auto-Answer message in step 830. The IMS core A 700c performs QoS authentication in step 832, and transmits the 200 OK message to the PoC subscriber terminal A 700a in step 834.

Upon receiving the 200 OK message, the PoC subscriber terminal A 700a transmits an ACK message to the IMS core A 700c in response thereto in step 836. The PoC subscriber terminal A 700a and a PS domain A 700b establish a PDP context appropriate for media in step 838, and the IMS core A 700c transmits the ACK message to the PoC AS A 700d in step 840.

In the meantime, upon receiving the Invite message in step 824, the IMS core B 702c performs a QoS authentication procedure in step 842, and transmits the Invite message to a PS domain B 702b in step 844. Upon receiving the Invite message, the PS domain B 702b performs a paging procedure in step 846, because the PoC subscriber terminal B 702a may be in an idle or dormant state, and then transmits the Invite message to the PoC subscriber terminal B 702a in step 848. The PoC subscriber terminal B 702a transmits a 200 OK message to the IMS core B 702c in response to the Invite message in step 850, and establishes a PDP context appropriate for media between the PS domain B 702b and the PoC subscriber terminal B 702a in step 852.

Upon receiving the 200 OK message in step 850, the IMS core B 702c transmits the 200 OK message to the PoC AS B 702d in step 854, and the PoC AS B 702d transmits the 200 OK message to the IMS core B 702c in step 856. Then the IMS core B 702c transmits the 200 OK message to the IMS core A 700c in step 858, and the IMS core A 700c transmits the 200 OK message to the PoC AS A 700d in step 860.

The PoC AS A 700d transmits the 200 OK message back to the IMS core A 700c in step 862, and the IMS core A 700c transmits an ACK message to the IMS core B 702c in response to the 200 OK message in step 864. Upon receiving the ACK message, the IMS core B 702c transmits the received ACK message to the PoC AS B 702d in step 866, and the PoC AS B 702d transmits the ACK message back to the IMS core B 702c in step 868. Then, the IMS core B 702c transmits the ACK message to the PoC subscriber terminal B 702a in step 870, and the PoC subscriber terminal A 700a and the PoC subscriber terminal B 702a perform a call in the full duplex mode in step 872.

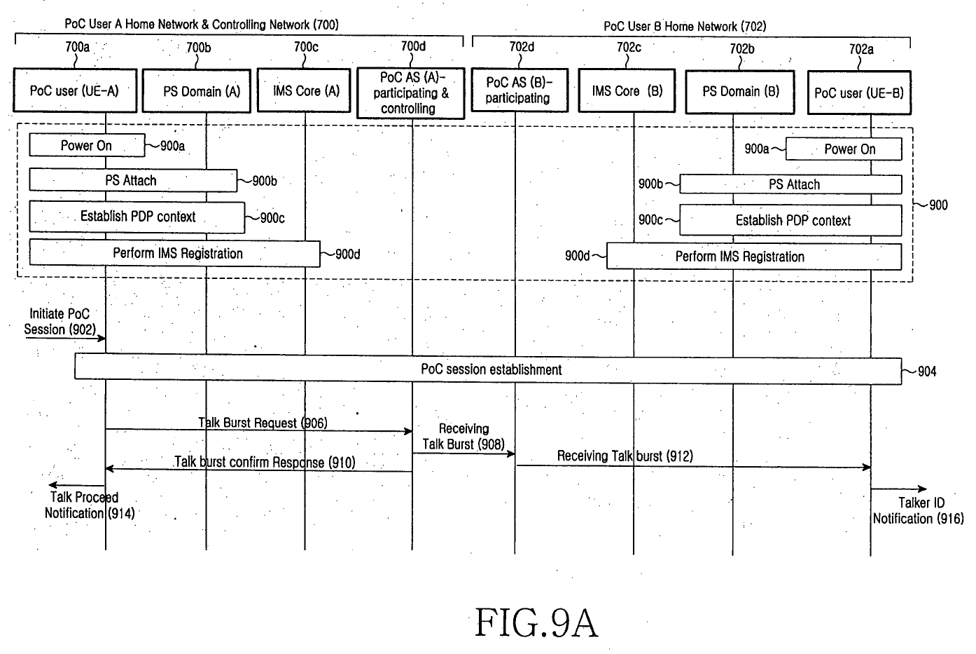

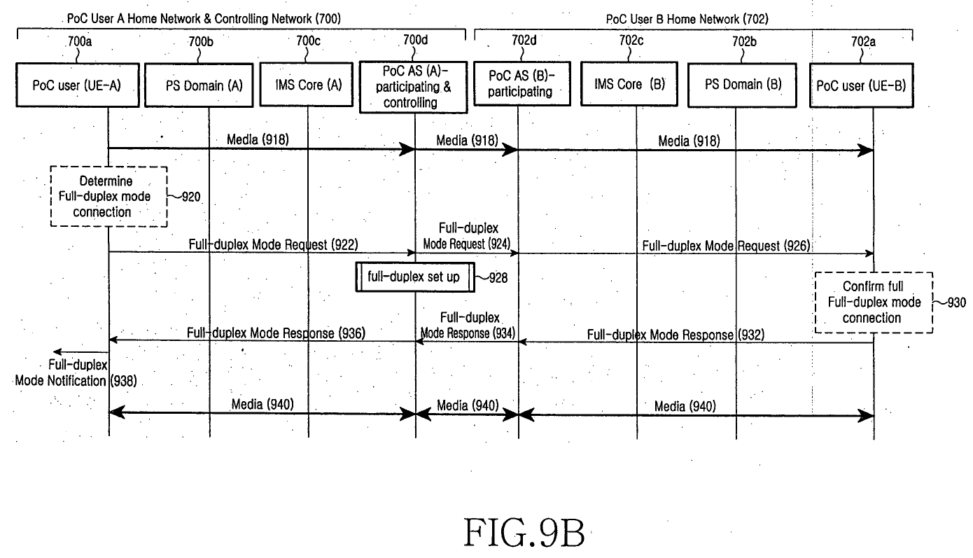

FIGS. 9A and 9B set forth a call flow diagram for servicing a full duplex call in response to a user's request during a half duplex call in an IMS-based PoC standard according to a sixth exemplary embodiment of the present invention.

In step 900, a PoC user A 700a and a PoC user B 702a should complete a registration process for using PTT service in the following procedure. Each of the users, that is, the PoC subscriber terminal A 700a and the PoC Subscriber terminal B 702a, powers ON the terminal in step 900a, registers itself in its associated one of PS domains 700b and 702b in step 900b, establishes a PDP context in step 900c, and finally performs IMS registration in step 900d, completing the registration process for PTT service.

If the calling party pushes a PTT button of the PoC subscriber terminal A 700a to request PoC service in step 902, starting a PoC session, then a PoC session for the general half duplex mode is established between the PoC subscriber terminal A 700a and the PoC subscriber terminal B 702a in step 904. The succeeding steps 906 through 918 correspond to a process of performing a call between the PoC subscriber terminals 700a and 702a by controlling a floor according to the contents described in the IMS-based PoC standard, and a brief description thereof will be given below.

If the PoC subscriber terminal A 700a transmits a Talk Burst Request message for requesting a floor to a PoC AS A 700d in step 906, the PoC AS A 700d transmits a Receiving Talk Burst message to a PoC AS B 702d in step 908 to approve receipt of the message transmitted from the PoC subscriber terminal A 700a, because the floor is given to the PoC subscriber terminal A 700a.

The PoC AS A 700d transmits a Talk Burst Confirm Response message to the PoC subscriber terminal A 700a in step 910 to confirm that the floor is given to the PoC subscriber terminal A 700a. The PoC AS B 702d transmits the Receiving Talk Burst message to the PoC subscriber terminal B 702a in step 912. Upon receiving the Talk Burst Confirm Response message in step 910, the PoC subscriber terminal A 700a informs the calling party in step 914 that the floor is given thereto, and the PoC subscriber terminal B 702a determines in step 916 which user has the floor.

In step 918, a PTT call between the PoC subscriber terminal A 700a and the PoC subscriber terminal B 702a is performed in the general half duplex mode. If the user of the PoC subscriber terminal A 700a operating in the half duplex mode determines to perform a direct call in the full duplex mode with the user of the PoC subscriber terminal B 702a in step 920, the PoC subscriber terminal A 700a transmits a Full-Duplex Mode Request message to the PoC AS A 700d with the RTCP protocol in step 922. Upon receiving the Full-Duplex Mode Request message, the PoC AS A 700d transmits the Full-Duplex Mode Request message to the PoC AS B 702d in step 924, and the PoC AS B 702d transmits the Full-Duplex Mode Request message to the PoC subscriber terminal B 702a in step 926.

The Full-Duplex Mode Request message transmitted in step 922 by the PoC subscriber terminal A 700a may be transmitted with the SIP protocol instead of the RTCP protocol, and a particular value of the Full-Duplex Mode Request message can be set before being transmitted, so the PoC AS A 700d receiving the Full-Duplex Mode Request message can perform a procedure for operating in the full duplex mode. It is assumed herein that the Full-Duplex Mode Request message is transmitted with the RTCP protocol, and a description thereof has been given with reference to FIGS. 5A-5C.

Upon receiving the Full-Duplex Mode Request message in step 922, the PoC AS A 700d operates in the full duplex mode in step 928, and a description thereof has been given with reference to FIG. 6.

Upon receiving the Full-Duplex Mode Request message in step 926, the PoC subscriber terminal B 702a determines in step 930 whether to operate in the full duplex mode. If the PoC subscriber terminal B 702a determines in step 930 to operate in the full duplex mode requested by the PoC subscriber terminal A 700a, the PoC subscriber terminal B 702a transmits a Full-Duplex Mode Response message to the PoC AS B 702d in step 932 and the PoC AS B 702d transmits the Full-Duplex Mode Response message to the PoC AS A 700d in step 934. Upon receiving the Full-Duplex Mode Response message, the PoC AS A 700d transmits the Full-Duplex Mode Response message to the PoC subscriber terminal A 700a in step 936, and the PoC subscriber terminal A 700a informs its user in step 938 that he/she can operate in the full duplex mode.

After the foregoing processes, the PoC subscriber terminal A 700a and the PoC subscriber terminal B 702a can perform a call in the full duplex mode in step 940.

Although an exemplary embodiment of the present invention has been described only for the 1:1 direct call between users, the full duplex call is possible even in a group call when necessary.

As can be understood from the foregoing description, an exemplary embodiment of the present invention allows a 1:1 direct call between users in the full duplex mode in a PoC system supporting the general half duplex mode between subscribers, thereby enabling free and rapid conversation. In addition, certain exemplary implementations of the present invention contribute to a reduction in the overall call time because the floor control process is not performed.

While the invention has been shown and described with reference to a certain exemplary embodiment thereof, it will be understood by those skilled in the art that various changes in form and details may be made therein without departing from the spirit and scope of the invention as defined by the appended claims and their equivalents.

What is claimed is:

1. A system for servicing a full duplex call in Push-To-Talk over cellular (PoC) in a communication system comprising at least two terminals for receiving a Push-To-Talk (PTT) service and a mobile network for providing the PTT service to the terminals, the system comprising:
a terminal for generating a full-duplex mode request message, transmitting the full-duplex mode request message to the mobile network, and operating in a full duplex mode upon receiving a response to the full-duplex mode request message; and
a PoC server for setting the terminal to the full duplex mode and performing the PTT service in the full duplex mode;
wherein, when there is a PTT service request, the terminal generates a full-duplex mode request message, transmits the full-duplex mode request message to the mobile network, and operating in the full duplex mode upon receiving the response to the full-duplex mode request message,
and upon receiving the full-duplex mode request message from the terminal, the PoC server sets the terminal to the full duplex mode and performs the PTT service in the full duplex mode.

2. The system of claim 1, further comprising a Session Initiation Protocol (SIP)/Internet Protocol (IP) core interposed between the terminal and the PoC server, for converting the full-duplex mode request message transmitted by the terminal into an SIP/IP format.

3. The system of claim 1, further comprising a packet switched (PS) domain and an IP Multimedia Subsystem (IMS) core interposed between the mobile network connected to the terminal and the PTT server, for exchanging IP-based packet data with the terminal.

4. The system of claim 1, wherein the full-duplex mode request message is transmittable in response to an initial communication request.

5. The system of claim 4, wherein the full-duplex mode request message comprises a Session Description Protocol (SDP) a-line of a Talk Burst Control Protocol among information elements of an SIP set to:
a=poc-lock:unlock.

6. The system of claim 1, wherein the full-duplex mode request message is transmittable during a PTT call.

7. The system of claim 6, wherein the full-duplex mode request message comprises a subtype field in a Real Time control Protocol (RTCP) message format set to:
11111.

8. A method for servicing a full duplex call in a Push-To-Talk over cellular (PoC) in a communication system comprising at least two calling/called terminals for receiving a Push-To-Talk (PTT) service and a mobile network for providing the PTT service to the calling/called terminals, the method comprising the steps of:
generating, by a calling terminal, a full-duplex mode request message and transmitting the full-duplex mode request message to a mobile network;
transmitting, by the mobile network, the full-duplex mode request message to a PoC server, the PoC server providing a PoC service to the calling terminal;
upon receiving the full-duplex mode request message, setting, by a PoC server of the calling terminal, the calling terminal to a full duplex mode;
transmitting, by the PoC server of the calling terminal, the full-duplex mode request message to a PoC server of the called terminal;
transmitting, by the PoC server of the called terminal, the full-duplex mode request message to the called terminal; and
performing a call between the calling terminal and the called terminal in the full duplex mode if the called terminal responds to the full-duplex mode request message.

9. The method of claim 8, wherein the fill-duplex mode request message, transmitted when the calling terminal desires to perform a call in the full duplex mode with the called terminal during initial communication, comprises a Session Description Protocol (SDP) a-line of a Talk Burst Control Protocol among information elements of an SIP set to:
a=poc-lock:unlock.

10. The method of claim 8, further comprising the step of setting a subtype field in a Real Time control Protocol (RTCP) message format to 11111, when the calling terminal desires to perform a call in the full duplex mode during a PTT call.

11. The method of claim 8, further comprising the step of, upon receiving the full-duplex mode request message, sending, by a PoC server of the calling terminal, a request for an operation in the full duplex mode to the called terminal and performing a call between the calling terminal and the called terminal in the full duplex mode.
